(19) United States
(12) Patent Application Publication
(10) Pub. No.: US 2019/0157017 A1
(43) Pub. Date: May 23, 2019

(54) DRIVE SYSTEM FOR HIGH-VOLTAGE ELECTRICAL DEVICES

(71) Applicant: ORMAZABAL Y CÍA, S.L.U., IGORRE (ES)

(72) Inventors: Juan María Casado Cartón, IGORRE (ES); José Luis Sabas Fernandez, IGORRE (ES)

(21) Appl. No.: 16/196,582

(22) Filed: Nov. 20, 2018

(30) Foreign Application Priority Data
Nov. 21, 2017 (EP) 17382786.6

(51) Int. Cl. H01H 3/54; H01H 3/32; H01H 33/42

(52) U.S. Cl. CPC H01H 3/54; H01H 33/42; H01H 3/32

(57) ABSTRACT

The present invention relates to a drive system for high-voltage electrical devices, such as a load break switch-disconnector and a grounding disconnector, which can be applied in utility grids, allowing said drive system to motorize the switching of both electrical devices. To that end, the drive system comprises a subassembly which allows selecting the motorized switching operation of the first electrical device or the motorized switching operation of the second electrical device. The motorization of the switching of both electrical devices thereby allows performing said operation remotely.

### CROSS-REFERENCE TO RELATED APPLICATION

This application claims benefit of European Patent Application No. 17382786.6 filed on Nov. 21, 2017, herein incorporated by reference in its entirety.

### OBJECT OF THE INVENTION

The present invention relates to a drive system for high-voltage electrical devices, such as a load break switch-disconnector or a grounding disconnector, for example, said drive system comprising a subassembly that allows motorizing the switching of at least two manually operated electrical devices, such as the switching of a load break switch-disconnector and a grounding disconnector, for example.

### BACKGROUND OF THE INVENTION

The electrical equipment used in utility grids may comprise electrical switching devices that carry out the connection, breaking and/or disconnecting and grounding the installation. Therefore in the event of, for example, a fault in the distribution line, an outage due to works, maintenance or optimization of the load distribution, such electrical devices can be actuated remotely to obtain the desired electric power distribution, to prevent consumers from being left without power or to assure the protection of people and electrical equipment such as transformers, for example.

These high-voltage electrical devices may consist of circuit breakers, load break switches, grounding disconnectors, etc., provided with a movable contact and a fixed contact. To perform these switching functions, a drive force produced by a drive system is transmitted to the movable contact of the high-voltage electrical device. The intervention of the drive system can be both voluntary, ordered by an operator regardless of the current value, and due to the action of a device that is sensitive to given current values which directly or indirectly order the circuit to be opened.

In electrical equipment in which a load break switch-disconnector and a grounding disconnector have been arranged, where the load break switch-disconnector is in charge of performing the operations for connecting and breaking/disconnecting the circuit and the grounding disconnector is in charge of connecting the circuit to the ground or disconnecting it from same, the switching of the load break switch-disconnector can typically be manual or motorized, whereas switching of the grounding disconnector is usually manual.

The fact that the switching of the grounding disconnector may not be motorized may entail several drawbacks, such as the risk that an operator may suffer an accident to the manual switching of the grounding disconnector without first resolving a fault existing in the grid or due to the performance of a false switching in the grid, for example. Likewise, though not such a serious drawback as the drawback of suffering an accident, not motorizing the switching of the grounding disconnector entails at least one operator having to go to the installation, such as when performing a line transfer, for example.

There are examples in the state of the art in which the switching of the grounding disconnector is in fact motorized, but in these cases, the switching of the load break switch-disconnector typically is not. Therefore, only examples in which the switching is motorized for just one of the electrical devices, i.e., for the load break switch-disconnector or for the grounding disconnector, have been known up until now. On the other hand, for reasons of safety both electrical devices can never be acted on at the same time, there being interlocks to prevent said joint switching.

### DESCRIPTION OF THE INVENTION

The present invention relates to a drive system for high-voltage electrical devices, such as a load break switch-disconnector or a grounding disconnector, for example, with at least two switching positions, a first connection position and a second opening position, which can be applied in high-voltage utility grids, and comprising at least one fixed contact and one movable contact, the movable contact being attached to a drive system such as the drive system of the present invention.

The drive system comprises a main drive assembly and a subassembly coupleable to at least a first electrical device (such as a load break switch-disconnector, for example) and a second electrical device (such as a grounding disconnector, for example), allowing the drive system to transmit at least two switching positions (connection and opening) to the first electrical device or the second electrical device.

The subassembly coupleable to the first electrical device or the second electrical device therefore allows switching both electrical devices by a single drive system. To that end, said subassembly comprises coupling of at least two working positions, the first position being associated with the first electrical device and the second position being associated with the second electrical device.

The switching of the electrical devices is preferably a motorized switching operation, where the movement generator may be a hydraulic device, pneumatic device, electrical device, magnetic device, inertial device, thermal device, hybrid device, etc., such that the coupling can be operated remotely. Therefore, both the first electrical device and the second electrical device can be switched remotely, thereby preventing the risk of suffering an accident due to the manual switching of one of the two electrical devices, such as due to the manual switching of a grounding disconnector in fault conditions, for example. Likewise, due to the motorization of the switching of both electrical devices, operators do not have to go to the installation to perform jobs of this type. However, for reasons of operator safety manual switching will always take priority over motorized switching, such that manual switching can override any motorized order.

The coupling mechanism can comprise a driving element which is in turn associated with a mechanical coupler. This mechanical coupler is integrally attached to a drive shaft of a motor. In this sense, the driving element can displace said mechanical coupler in one direction or the other on said drive shaft of the motor depending on the order that is given, i.e., a connection order or opening order. The mechanical coupler can thereby be coupled to a first coupling element or a second coupling element, the first coupling element being associated with the first electrical device and the second coupling element being associated with the second electrical device.

Therefore, the coupling mechanisms in their first position couple the motor with the first coupling element (which may consist of a gear, chain, etc.), such that the drive system can transmit at least two switching positions (connection and opening) in a motorized manner to the first electrical device, such as a load break switch-disconnector, for example. On the other hand, the coupling mechanisms in their second position couple the motor with the second coupling element (which may consist of a gear, chain, etc.), such that the drive system can transmit at least two switching positions (connection and opening) in a motorized manner to the second electrical device, such as a grounding disconnector, for example.

The coupling mechanisms, which may be a coil, comprise a third intermediate working position with respect the first position and the second position, wherein by this third position the coupling mechanisms decouple the motor from the first coupling element and from the second coupling element. This third position of the coupling mechanisms is reached after the switching of the electrical device has been performed, and therefore after the coupling mechanisms have been de-energized.

The subassembly comprises a shell in which all its elements are internally assembled, and said shell is attached to the main drive assembly, thereby forming a drive system configured as a single part.

The possibility of the coupling mechanisms being able to be operated manually has been contemplated, such that once the mechanical coupler has been manually displaced in a direction or the other on the drive shaft of the motor, the latter acts on the first coupling element or the second coupling element in order to carry out the switching of the first electrical device or the second electrical device.

### DESCRIPTION OF THE DRAWINGS

FIG. 1 shows a perspective view of the drive system comprising the main drive assembly and the subassembly with the coupling mechanisms and the motor.

FIG. 2 shows a diagram of the subassembly comprising the coupling mechanisms with the driving element, the mechanical coupler, the motor with its drive shaft and the coupling elements.

FIG. 3 shows a diagram with the working positions of the coupling mechanisms.

### PREFERRED EMBODIMENT OF THE INVENTION

A preferred embodiment is described below in reference to the aforementioned drawings, without this limiting or reducing the scope of protection of the present invention.

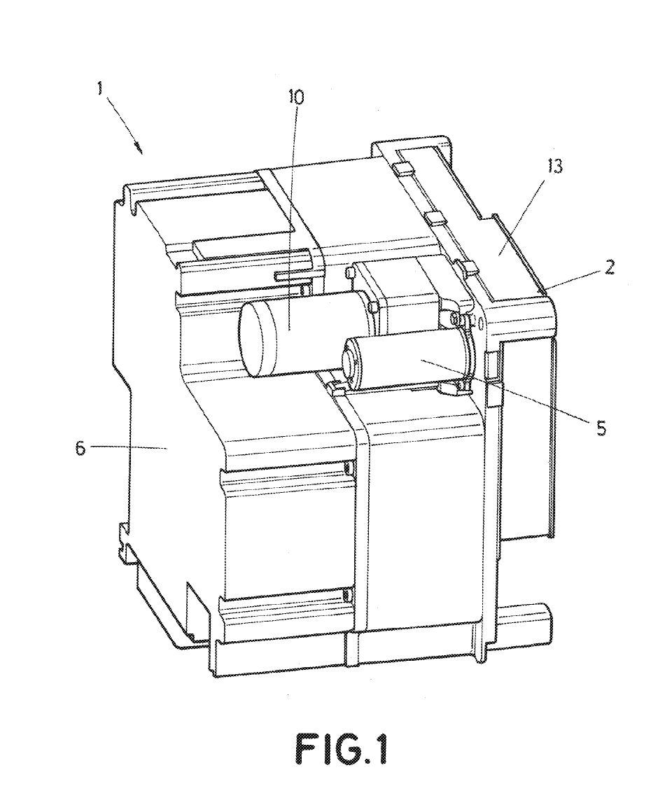

FIG. 1 shows the drive system (1) comprising a main drive assembly (6) and a subassembly (2). The subassembly (2) allows motorizing the switching of a first electrical device (3) and a second electrical device (4), allowing the drive system (1) to transmit two switching positions (connection and opening) to the first electrical device (3) or the second electrical device (4) in a motorized manner. The invention thereby enables performing remotely, without an operator having to go to the installation, the switching for the connection or for the opening of the first electrical device (3), such as a load break switch-disconnector, for example, and the switching for the connection or for the opening of the second electrical device (4), such as a grounding disconnector, for example.

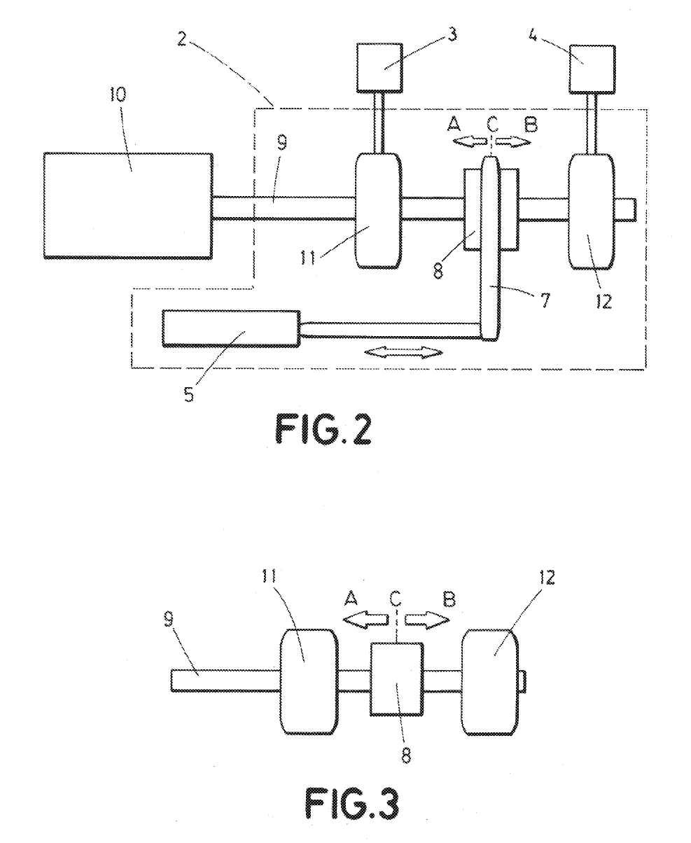

The subassembly (2) therefore allows coupling the main drive assembly (6) with the first electrical device (3) or the second electrical device (4), for the purpose of transmitting two switching positions (connection-opening) to said electrical devices (3, 4). To that end, the subassembly (2) comprises coupling mechanism (5), such as a coil, for example, for linear displacement of three working positions (A, B, C), wherein the first position (A) is associated with the first electrical device (3) and the second position (B) is associated with the second electrical device (4). The third position (C) is located in an intermediate position between the first position (A) and the second position (B), this third position (C) being a neutral position with respect to the other two positions (A, B), as shown in FIGS. 2 and 3.

As can be seen in FIG. 2, the coupling mechanism (5) comprise a driving element (7), such as a bearing, which is displaced linearly in the aforementioned three working positions (A, B, C). This driving element (7) is associated with a mechanical coupler (8), where this mechanical coupler (8) may present circular movement caused by the drive shaft (9) of a motor (10). Due to the displacement of the driving element (7), the mechanical coupler (8) can be coupled to a first coupling element (11) or a second coupling element (12), depending on the position (A, B) to which the driving element (7) is displaced. Therefore, the coupling between the mechanical coupler (8) and the first coupling element (11) causes the switching (opening or connection) of the first electrical device (3), and the coupling between the mechanical coupler (8) and the second coupling element (12) causes the switching (opening or connection) of the second electrical device (4). In other words, the coupling mechanism (5) in their first position (A) couple the motor (10) with a first coupling element (11), such that the drive system (1) can transmit two switching positions, i.e., the opening or connection of the contacts of the first electrical device (3), to said first electrical device (3), and on the other hand, the coupling mechanism (5) in their second position (B) couple the motor (10) with a second coupling element (12), such that the drive system (1) can transmit at least two switching positions, i.e., the opening or connection of the contacts of the second electrical device (4), to said second electrical device (4). In contrast, the coupling mechanism (5) in their third position (C) decouple the motor (10) from the coupling elements (11, 12). This third position (C) of the coupling mechanism (5) is reached after the switching of the first electrical device (3) or the second electrical device (4) has been performed, and the coupling mechanism (5) has therefore been de-energized.

As shown in FIG. 1, the subassembly (2) comprises a shell (13) in which some elements of the mentioned subassembly (2) are internally assembled, such as the driving element (7), the mechanical coupler (8) and the coupling elements (11, 12). The subassembly (2) is thereby attached to the main drive assembly (6), forming a single part consisting of the drive system (1).

What is claimed is:

1. A drive system for high-voltage electrical devices comprising:
a main drive assembly; and
a subassembly coupleable to at least a first electrical device and a second electrical device for the transmission of at least two switching positions,
characterized in that the subassembly comprises a coupling mechanism of at least two positions, a first position being associated with the first electrical device and a second position being associated with the second electrical device.

2. The drive system according to claim 1, characterized in that the coupling mechanism comprises a third position located in an intermediate location between the first position and the second position.

3. The drive system according to claim 2, characterized in that the coupling mechanism comprises a driving element associated with a mechanical coupler, wherein said driving element is suitable for being linearly displaced in the first, second and third positions.

4. The drive system according to claim 3, characterized in that the mechanical coupler is integrally attached to a drive shaft of a motor.

5. The drive system according to claim 3, characterized in that the mechanical coupler can be coupled to a first coupling element or a second coupling element.

6. The drive system according to claim 5, characterized in that the first coupling element is associated with the first electrical device and the second coupling element is associated with the second electrical device.

7. The drive system according to claim 4, characterized in that the coupling mechanism in its first position couples the motor with a first coupling element, such that the drive system can transmit at least two switching positions to the first electrical device.

8. The drive system according to claim 4, characterized in that the coupling mechanism in its second position couples the motor with a second coupling element, such that the drive system can transmit at least two switching positions to the second electrical device.

9. The drive system according to claim 7, characterized in that the coupling mechanism in its third position decouples the motor from the first coupling element.

10. The drive system according to claim 8, characterized in that the coupling mechanism in its third position decouples the motor from the second coupling element.

11. The drive system according to claim 9, characterized in that the coupling mechanism can be operated in a manual or motorized manner.

12. The drive system according to claim 10, characterized in that the coupling mechanism can be operated in a manual or motorized manner.

13. The drive system according to claim 11, characterized in that a coil constitutes the coupling mechanism.

14. The drive system according to claim 12, characterized in that a coil constitutes the coupling mechanism.

15. The drive system according to claim 1, characterized in that the subassembly comprises a shell.

16. The drive system according to claim 15, characterized in that the shell is attached to the main drive assembly, forming a drive system configured as a single part.
